(19) United States
(12) Patent Application Publication
(10) Pub. No.: US 2011/0280284 A1
(43) Pub. Date: Nov. 17, 2011

(54) WIRELESS COMMUNICATION TERMINAL DEVICE AND METHOD OF SIGNAL DIFFUSION

(75) Inventors: Seigo Nakao, Kanagawa (JP); Daichi Imamura, Kanagawa (JP); Akihiko Nishio, Kanagawa (JP); Kenichi Miyoshi, Kanagawa (JP); Megumi Ichikawa, Kanagawa (JP)

(73) Assignee: Panasonic Corporation, Osaka (JP)

(21) Appl. No.: 13/141,155

(22) PCT Filed: Dec. 22, 2009
(86) PCT No.: PCT/JP2009/007114

§ 371 Date: Aug. 3, 2011

(30) Foreign Application Priority Data
Dec. 24, 2008 (JP) 2008-328731

(51) Int. Cl. H04B 1/707

(52) U.S. Cl. 375/140; 375/E01.002

(57) ABSTRACT

Disclosed is a wireless communication terminal device that is capable of preventing inter-coding interference upon each of a plurality of base stations, even when the timing changes for a transmission of a control signal that is CoMP received by the plurality of base stations. Upon the device, a diffusion unit (214) employs any of a plurality of ZAC series that are reciprocally splittable with a reciprocally variable cyclical shift quantity to diffuse a response signal, according to an instruction from a control unit (209), and the control unit (209) controls, according to a difference between a timing of a transmission of a response signal at a first time and a timing of a transmission of a response signal at a second time that is later than the first time, the cyclical shift quantity of the ZAC series that is employed by the diffusion unit (214) at the second time.

### TECHNICAL FIELD

The present invention relates to a radio communication terminal apparatus and signal spreading method.

### BACKGROUND ART

In 3GPP LTE, SC-FDMA (Single Carrier-Frequency Division Multiple Access) is used as an uplink communication method (see Non-Patent Literature 1, for example). In 3GPP LTE, a radio communication base station apparatus (hereinafter referred to simply as “base station”) allocates an uplink data resource to a radio communication terminal apparatus (hereinafter referred to simply as “terminal”) via a physical channel (for example, a PDCCH (Physical Downlink Control Channel)).

In 3GPP LTE, HARQ (Hybrid Automatic Repeat reQuest) is applied to downlink data from a base station to a terminal. That is to say, a terminal feeds back a response signal indicating a downlink data error detection result to a base station. A terminal performs a CRC (Cyclic Redundancy Check) check on downlink data, and feeds back ACK (Acknowledgment) to a base station as a response signal if CRC=OK (no error), or NACK (Negative Acknowledgment) if CRC=NG (error present). A terminal transmits this response signal (that is, ACK/NACK signal) to a base station using an uplink control channel such as a PUCCH (Physical Uplink Control Channel).

FIG. 1 is a drawing showing PUCCH resource placement in 3GPP LTE. A PUSCH (Physical Uplink Shared Channel) shown in FIG. 1 is a channel used for terminal uplink data transmission, and is used when a terminal transmits uplink data. As shown in FIG. 1, PUCCHs are placed at both ends of a system band—specifically, in resource blocks (RB: Resource Block or PRB: Physical RB) at both ends of the system band. PUCCHs placed at both ends of the system band are switched around among slots—that is, subjected to frequency hopping on a slot-by-slot basis.

Also, as shown in FIG. 2, a plurality of response signals from a plurality of terminals are spread using a ZAC (Zero Auto Correlation) sequence and Walsh sequence. In FIG. 2, [W₀, W₁, W₂, W₃] represents a Walsh sequence with a sequence length of 4. As shown in FIG. 2, in a terminal an ACK or NACK response signal first undergoes first spreading in the frequency domain by means of a sequence having a time domain characteristic of a ZAC sequence (sequence length: 12). Then a response signal that has undergone first spreading undergoes an IFFT (Inverse Fast Fourier Transform) in correspondence to W₀ through W₃. A response signal spread in the frequency domain is converted to a ZAC sequence with a sequence length of 12 in the time domain by means of this IFFT. Then a post-IFFT signal further undergoes second spreading using a Walsh sequence (sequence length: 4). That is to say, one response signal is placed in four SC-FDMA symbols S₀ through S₃. A response signal is also spread using a ZAC sequence and Walsh sequence in a similar way by other terminals. However, in different terminals, ZAC sequences with mutually different Cyclic Shift values in the time domain, or mutually different Walsh sequences, are used. Here, since the sequence length in the time domain of a ZAC sequence is 12, 12 ZAC sequences with cyclic shift values of 0 through 11 generated from the same ZAC sequence can be used. Also, since the sequence length of a Walsh sequence is 4, four mutually different Walsh sequences can be used. Therefore, in an ideal communication environment, response signals from a maximum of 48 (12×4) terminals can be code-multiplexed.

Also, as shown in FIG. 2, a plurality of reference signals (pilot signals) from a plurality of terminals are also code-multiplexed. As shown in FIG. 2, when three reference signal symbols R₀, R₁, R₂ are generated from a ZAC sequence (sequence length: 12), first, the ZAC sequence undergoes IFFT in correspondence to a Fourier sequence or suchlike orthogonal sequence [F₀, F₁, F₂,] with a sequence length of 3. By means of this IFFT, a ZAC sequence with a sequence length of 12 in the time domain is obtained. Then a post-IFFT signal is spread using orthogonal sequence [F₀, F₁, F₂]. That is to say, one reference signal (ZAC sequence) is placed in three SC-FDMA symbols Ro, R₁ and R₂. In other terminals, too, one signal (ZAC sequence) is placed in three SC-FDMA symbols R₀, R₁ and R₂. However, in different terminals, ZAC sequences with mutually different cyclic shift values in the time domain, or mutually different orthogonal sequences, are used. Here, since the sequence length in the time domain of a ZAC sequence is 12, 12 ZAC sequences with cyclic shift values of 0 through 11 generated from the same ZAC sequence can be used. Also, since the sequence length of an orthogonal sequence is 3, three mutually different orthogonal sequences can be used. Therefore, in an ideal communication environment, reference signals from a maximum of 36 (12×3) terminals can be code-multiplexed.

Then, as shown in FIG. 2, one slot is configured by means of 7 symbols S₀, S₁, R₀, R₁, R₂, S₂ and S₃.

Here, correlation between ZAC sequences with mutually different cyclic shift values generated from the same ZAC sequence is theoretically 0. Therefore, in an ideal communication environment, a plurality of response signals spread by ZAC sequences with mutually different cyclic shift values (shift values of 0 through 11) can be separated with virtually no inter-code interference in the time domain by means of correlation processing by a base station.

However, because of influences such as a misalignment of transmitting timing at a terminal and a delayed wave caused by multipath, and so forth, a plurality of response signals from a plurality of terminals do not necessarily arrive at a base station simultaneously. For example, if the transmission timing of a response signal spread by a ZAC sequence with a cyclic shift value of 0 is later than the correct transmission timing, the correlation peak of a ZAC sequence with a cyclic shift value of 0 may appear in the detection window of a ZAC sequence with a cyclic shift value of 1. Also, if there is a delayed wave in a response signal spread by a ZAC sequence with a cyclic shift value of 0, interference leakage due to that delayed wave may appear in the detection window of a ZAC sequence with a cyclic shift value of 1. That is to say, in these cases, a ZAC sequence with a cyclic shift value of 1 receives interference from a ZAC sequence with a cyclic shift value of 0. On the other hand, if the transmission timing of a response signal spread by a ZAC sequence with a cyclic shift value of 1 is earlier than the correct transmission timing, the correlation peak of a ZAC sequence with a cyclic shift value of 1 may appear in the detection window of a ZAC sequence with a cyclic shift value of 0. That is to say, in this case, a ZAC sequence with a cyclic shift value of 0 receives interference from a ZAC sequence with a cyclic shift value of 1. Therefore, in these cases, a separation characteristic between a response signal spread by a ZAC sequence with a cyclic shift value of 0 and a response signal spread by a ZAC sequence with a cyclic shift value of 1 degrades. That is to say, when ZAC sequences with mutually adjacent cyclic shift values are used, there is a possibility of the separation characteristic of response signals degrading.

Thus, conventionally, when a plurality of response signals are code-multiplexed by means of ZAC sequence spreading, a cyclic shift interval (cyclic shift value difference) sufficient to prevent inter-code interference between ZAC sequences is provided between ZAC sequences. For example, a cyclic shift interval between ZAC sequences is made 2, and, of 12 ZAC sequences with cyclic shift values of 0 through 11, only six ZAC sequences with cyclic shift values of 0, 2, 4, 6, 8 and 10, or cyclic shift values of 1, 3, 5, 7, 9 and 11, are used for first spreading of a response signal. Therefore, when a Walsh sequence with a sequence length of 4 is used for second spreading, response signals from a maximum of 24 (6×4) terminals can be code-multiplexed.

However, since the sequence length of an orthogonal sequence used for reference signal spreading is 3, as shown in FIG. 2, only three mutually different orthogonal sequences can be used for reference signal spreading. Therefore, when a plurality of response signals are separated using the reference signal shown in FIG. 2, only response signals from a maximum of 18 (6×3) terminals can be code-multiplexed. Therefore, since it is sufficient for there to be three Walsh sequences out of the four Walsh sequences with a sequence length of 4, one of the Walsh sequences is not used.

Also, defining 18 PUCCHs such as shown in FIG. 3 (ACK #1 through ACK ™18 shown in FIG. 3) as PUCCHs used for transmission of the above 18 response signals has been studied. In FIG. 3, the horizontal axis indicates a cyclic shift value, and the vertical axis indicates a sequence number of an orthogonal code sequence (a sequence number of a Walsh sequence or Fourier sequence).

In a 3GPP LTE PUCCH, a CQI (Channel Quality Indicator) signal is also multiplexed in addition to an above-described response signal (ACK/NACK signal). While a response signal is an one-symbol of information (information indicated by one symbol) as explained above, a CQI signal is a five-symbol of information. As shown in FIG. 4, a terminal spreads a CQI signal by means of a ZAC sequence with a sequence length of 12, and transmits a spread CQI signal after performing an IFFT. Thus, since a Walsh sequence is not applied to a CQI signal, a base station cannot use a Walsh sequence for separation of a response signal and a CQI signal. Thus, a base station uses a ZAC sequence to perform despreading of a response signal and CQI signal spread by means of ZAC sequences corresponding to different cyclic shifts, thereby separating a response signal and CQI signal with virtually no inter-code interference.

Standardization has begun on LTE-Advanced (hereinafter referred to as “LTE+”), which achieves a still higher communication speed than 3GPP LTE. Transmission/Reception: With LTE+, Coordinated Multipoint Transmission/Reception (CoMP transmission/reception) has been studied, whereby a plurality of base stations coordinate inter-cell interference by transmitting and receiving signals in a coordinated fashion, in order to improve average throughput and the throughput of a terminal located near a cell edge.

### CITATION LIST

### Non-Patent Literature

NPL 1
3GPP TS 36.211 V8.4.0, “Physical Channels and Modulation (Release 8),” September 2008

### SUMMARY OF INVENTION

### Technical Problem

CoMP transmission/reception is categorized as FCS (Fast Cell Selection) whereby one base station selected adaptively from among a plurality of base stations transmits and receives signals, and coordinated multipoint transmission/reception whereby a plurality of base stations transmit and receive signals to/from one terminal. For example, FIG. 5 shows a conceptual diagram of an example of a case in which a plurality of base stations perform CoMP transmission/reception to/from one terminal. In FIG. 5, a base station (serving eNB) to which a certain terminal (UE 1) belongs at a certain time transmits downlink data to UE 1. The three base stations shown in FIG. 5 (serving eNB, neighbour eNB1, and neighbour eNB2) hold the same downlink data in common beforehand, and the base station that transmits downlink data is adaptively controlled at high speed according to the downlink quality between each base station and UE 1 (that is to say, FCS is executed as CoMP transmission). FCS is also executed for a downlink control signal (not shown) in the same way as for downlink data.

Also, UE 1 transmits a response signal (ACKINACK) in response to downlink data and a downlink quality measurement result (CQI) (an uplink control signal shown in FIG. 5). Then, as shown in FIG. 5, the three base stations perform CoMP reception (coordinated multipoint reception) of uplink control signals from UE 1. At this time, the three base stations shown in FIG. 5 exchange, via backhaul, analog information (soft bit information) of uplink control signals received by each from UE 1. Then the serving eNB combines analog information of uplink control signals received by each of the three base stations, by Maximum Ratio Combining (MRC), for example, and performs uplink control signal decoding.

The three base stations shown in FIG. 5 perform CoMP reception not only of uplink control signals but also of uplink data. However, the information amount of uplink data is extremely large compared with the information amount of an uplink control signal, and the load for exchanging soft bit information via backhaul is great. Consequently, FCS is also used for CoMP reception of uplink data, in the same way as for downlink data (or downlink control signals). That is to say, a terminal (UE 1 shown in FIG. 5) transmits uplink data in accordance with a downlink control signal from a base station selected by means of FCS. Then uplink data transmitted from this terminal is received by one of the three base stations (in FIG. 5, serving eNB), and information is transmitted to the network side. In this way, uplink quality and downlink quality can be improved by having a plurality of base stations perform transmission/reception to/from one terminal in a coordinated fashion. For example, in FIG. 6 a terminal that is an object of CoMP transmission/reception by three base stations (cells 1 through 3) transmits uplink data with cell 1 selected by means of FCS as a serving cell, and in FIG. 7 uplink data is transmitted with cell 2 selected by means of FCS as a serving cell.

Incidentally, as stated above, SC-FDMA is used as a 3GPP LTE uplink communication method (uplink data transmission method), and a base station must separate Single Carrier signals from individual terminals that have been frequency-multiplexed by means of an FFT (Fast Fourier Transform). That is to say, at a base station, uplink data from all terminals must be within an FFT Window simultaneously. However, propagation distances from terminals to a base station vary, and uplink data from all terminals does not necessarily arrive at a base station simultaneously. For example, as shown in FIG. 8A, if four terminals (terminals A through D) transmit update data at individual transmission timings, there is a possibility of valid symbols from all terminals (for example, “Data” shown in FIG. 8A) not being included in an FFT window of a base station due to a terminal transmission timing error, the influence of a delayed wave, or the like. Thus, in the case of a 3GPP LTE uplink, uplink data transmission timing control is executed. For example, as shown in FIG. 8B, the reception timings of uplink data from all terminals can be aligned at a base station by having a base station specify appropriate transmission timing for all terminals (terminals A through D).

Here, in FIG. 6, cell 1 receives uplink data from a CoMP terminal. Consequently, CoMP terminal transmission timing is controlled so that uplink data arrives in cell 1 at optimal transmission timing for cell 1 by having cell 1 specify uplink data transmission timing (in FIG. 6, transmission timing 1). That is to say, in the case of cell 1 shown in FIG. 6, reception timing of uplink data from a CoMP terminal and reception timing of uplink data from communication terminal A coincide. Similarly, in FIG. 7, CoMP terminal transmission timing is controlled so that uplink data arrives in cell 2 at optimal transmission timing for cell 2 by having cell 2 specify uplink data transmission timing (in FIG. 7, transmission timing 2). That is to say, as shown in FIG. 6 and FIG. 7, timing at which uplink data is transmitted by a CoMP terminal differs according to which base station receives the uplink data. For example, when FCS is used for CoMP reception of uplink data, it is possible that the transmission timing of uplink data from a CoMP terminal will differ each time the base station that receives uplink data is updated. A difference between optimal transmission timing for cell 1 and optimal transmission timing for cell 2 may be due to a difference between the distance of cell 1 from the CoMP terminal and the distance of cell 2 from the CoMP terminal, or to a deviation in synchronization between cells in an uplink.

Also, as stated above, a CoMP terminal decides the transmission timing of uplink data transmitted by that CoMP terminal in accordance with transmission timings specified from each cell, and transmits uplink data accordingly. Here, a CoMP terminal executes transmission timing control for uplink control signals (a response signal and CQI signal) in the same way as for uplink data. However, an uplink control signal from a CoMP terminal is subjected to CoMP reception (coordinated multipoint reception) by a plurality of base stations. Consequently, uplink control signal transmission timing control that makes uplink control signal transmission timing optimal for all cells is impossible. Thus, one idea is to execute uplink control signal transmission timing control in synchronization with above-described uplink data transmission timing control. That is to say, uplink control signal transmission timing control is executed so that reception timing of a cell for which the distance to a CoMP terminal is shortest (uplink quality vis-a-vis a CoMP terminal is best) becomes optimal. At this time, for a cell other than a cell subject to uplink control signal (that is, uplink data) transmission timing control, there is a possibility of reception timing of an uplink control signal from a CoMP terminal deviating slightly from the optimal value. This deviation in reception timing can be absorbed to a certain extent by a GI (Guard Interval) (or CP (Cyclic Prefix)). Also, if deviation in reception timing is too great to be absorbed by a CP, provision could be made for preventing major degradation of CoMP performance in an uplink by means of a measure such as not using information of uplink control signals received, by each cell in MRC.

Furthermore, as explained above, uplink control signals (response signals and CQI signals) from a plurality of terminals are code-multiplexed, and a cyclic shift sequence (for example, a ZAC sequence) is used as an uplink control signal spread code. Since a cyclic shift sequence is a sequence in which a spread code waveform in the time domain is displaced cyclically (cyclically shifted), a cyclic shift sequence code resource can be represented by an amount of time by which cyclic shifting has been performed with respect to an original ZAC sequence.

Here, a case will be described in which, as shown in FIG. 6, a CoMP terminal performs transmission timing control in accordance with transmission timing adapted to cell 1 (transmission timing 1 shown in FIG. 6). In FIG. 6, a resource (PUCCH) occupied by an uplink control signal for CoMP communication is reported to the CoMP terminal during communication with cell 1. Specifically, the CoMP terminal is directed so that CoMP communication is configured during communication with cell 1, and during execution of optimal transmission timing control for cell 1, and a cyclic shift sequence with a cyclic shift value of 3 is used for uplink control signal transmission, as shown in FIG. 9A. In this case, a resource received by cell 1 that is subject to transmission timing control optimization—that is, a code resource occupied by an uplink control signal from the CoMP terminal—becomes a code resource with a cyclic shift value of 3, as shown in FIG. 9A. On the other hand, in the case of cell 2 and cell 3 shown in FIG. 6, since the timing at which an uplink control signal from the CoMP terminal arrives differs from the optimal reception timing of each cell, there is a possibility of an uplink control signal from the CoMP terminal occupying a code resource with a different cyclic shift value from cell 1. For example, an uplink control signal from the CoMP terminal is received occupying a code resource between a cyclic shift value of 4 and a cyclic shift value of 5 in cell 2 shown in FIG. 9A, and a code resource between a cyclic shift value of 3 and a cyclic shift value of 4 in cell 3. At this time, as shown in FIG. 9A for example, each of the base stations (cells 1 through 3) performs control that provides a cyclic shift interval between a resource (PUCCH) occupied by the CoMP terminal and a resource (PUCCH) occupied by a terminal other than that CoMP terminal that is sufficiently large to prevent interference being imposed on the code resources by an uplink control signal from the CoMP terminal.

A description will now be given of a ease in which, after the transmission timing shown in FIG. 6A, the CoMP terminal performs transmission timing control in accordance with transmission timing adapted to cell 2 (transmission timing 2 shown in FIG. 7), and transmits an uplink control signal using a code resource identical to the code resource shown in FIG. 9A (that is, a code resource with a cyclic shift value of 3). In FIG. 6 and FIG. 7, the propagation distance between the CoMP terminal and cell 2 is greater than the propagation distance between the CoMP terminal and cell 1. That is to say, taking propagation delay into consideration, CoMP terminal transmission timing 2 (optimal transmission timing for cell 2) in FIG. 7 is set as earlier timing than CoMP terminal transmission timing 1 (optimal transmission timing for cell 1) in FIG. 6. However, the code resource used by the CoMP terminal for uplink control signal transmission is the same in both FIG. 6 and FIG. 7 (a code resource with a cyclic shift value of 3). Consequently, as shown in FIG. 9B, in cell 2 an uplink control signal is received occupying a code resource with a cyclic shift value of 3, whereas in cell 1 and cell 3 an uplink control signal is received occupying a code resource between a cyclic shift value of 1 and a cyclic shift value of 2.

Thus, when uplink control signal transmission timing control is performed in accordance with transmission timing adapted to a specific cell, the apparently occupied code resource varies for each cell (cell 2 and cell 3 in FIG. 9A, cell 1 and cell 3 in FIG. 9B) even though the same code resource (a code resource with a cyclic shift value of 3 in FIG. 9A and FIG. 9B) is used by the CoMP terminal. Here, resources (PUCCHs shown in FIG. 9A) occupied by uplink control signals from terminals (the CoMP terminal and other terminals) controlled by the respective cells (cells 1 through 3) are the same in both FIG. 6 and FIG. 7. Therefore, in cells 1 through 3, at the timing (time) in FIG. 6, code resources (FIG. 9A) are set so that resources (PUCCHs) occupied by the respective terminals do not cause mutual interference. However, in this case too, it is possible that a code resource occupied by the CoMP terminal will occupy an unexpected code resource (FIG. 9B) in FIG. 7 showing a timing (time) later than FIG. 6 timing through readjustment of uplink control signal transmission tuning. For example, as shown in FIG. 9B, in cells other than cell 3 that is subject to transmission timing control optimization (that is, cell 1 and cell 2), inter-code interference occurs between a code resource occupied by an uplink control signal from the CoMP terminal and a code resource occupied by an uplink control signal from a terminal other than the CoMP terminal. Thus, when the transmission timing of an uplink control signal from the CoMP terminal changes, there is a possibility of inter-code interference occurring due to the fact that a code resource occupied by the CoMP terminal occupies an unexpected code resource.

It is therefore an object of the present invention to provide a radio communication terminal apparatus and signal spreading method capable of preventing inter-code interference in each of a plurality of base stations even when transmission timing of a control signal that is CoMP-received by the plurality of base stations changes.

### Solution to Problem

A terminal of the present invention employs a configuration having: a spreading section that spreads a signal using any of a plurality of sequences that are mutually separable by means of mutually different cyclic shift values; and a control section that controls, according to a difference between transmission timing of the signal at a first time and transmission timing of the signal at a second time that is later than the first time, a cyclic shift value of a sequence used by the spreading section at the second time.

A signal spreading method of the present invention has: a spreading step of spreading a signal using any of a plurality of sequences that are mutually separable by means of mutually different cyclic shift values; and a control step of controlling, according to a difference between transmission timing of the signal at a first time and transmission timing of the signal at a second time that is later than the first time, a cyclic shift value of a sequence used in the spreading step at the second time.

### Advantageous Effects of Invention

The present invention can prevent inter-code interference in each of a plurality of base stations even when transmission timing of a control signal that is CoMP-received by the plurality of base stations changes.

### BRIEF DESCRIPTION OF DRAWINGS

FIG. 1 is a drawing showing PUCCH resource placement (conventional);

FIG. 2 is a drawing showing a spreading method of a response signal and a reference signal (conventional);

FIG. 3 is a drawing showing response signal definition (conventional);

FIG. 4 is a drawing showing a CQI signal and reference signal spreading method (conventional);

FIG. 5 is a drawing showing the concept of CoMP transmission/reception (conventional);

FIG. 6 is a drawing showing CoMP reception of uplink data (conventional);

FIG. 7 is a drawing showing CoMP reception of uplink data (conventional);

FIG. 8A is a drawing showing uplink data transmission timing control;

FIG. 8B is a drawing showing uplink data transmission timing control;

FIG. 9A is a drawing showing PUCCHs occupied by each terminal;

FIG. 9B is a drawing showing PUCCHs occupied by each terminal;

FIG. 10 is a block diagram showing the configuration of a base station according to Embodiment 1 of the present invention;

FIG. 11 is a block diagram showing the configuration of a terminal according to Embodiment 1 of the present invention;

FIG. 12 is a drawing showing PUCCHs occupied by each terminal according to Embodiment 1 of the present invention;

FIG. 13 is a block diagram showing the configuration of a base station according to Embodiment 2 of the present invention;

FIG. 14 is a block diagram showing the configuration of a terminal according to Embodiment 2 of the present invention; and

FIG. 15 is a drawing showing PUCCHs occupied by each terminal according to Embodiment 2 of the present invention.

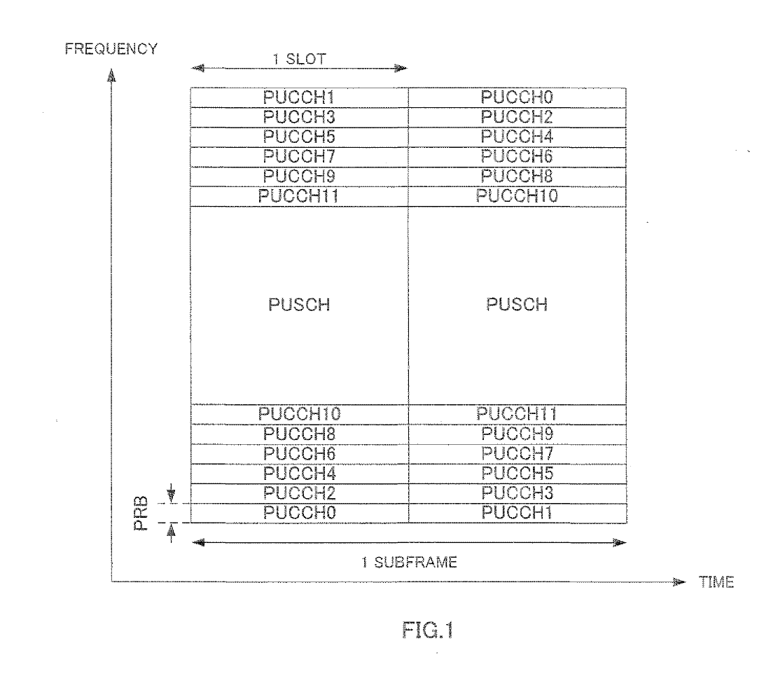

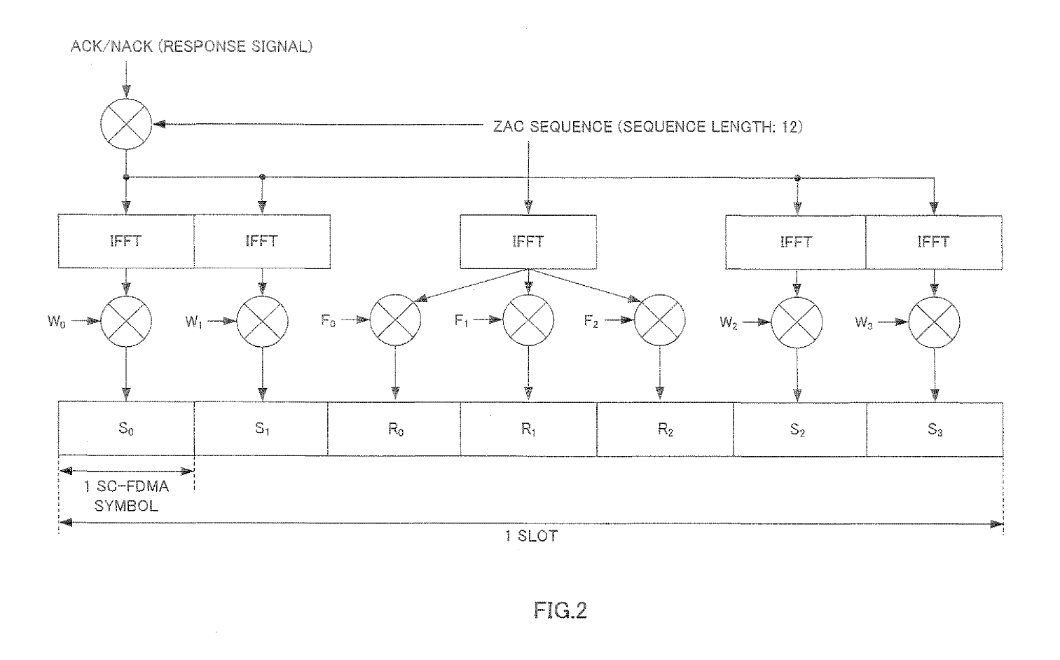

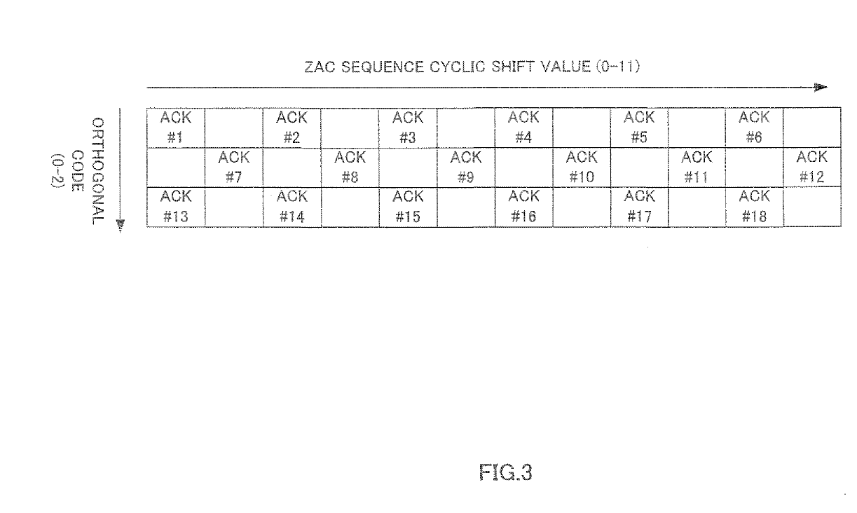

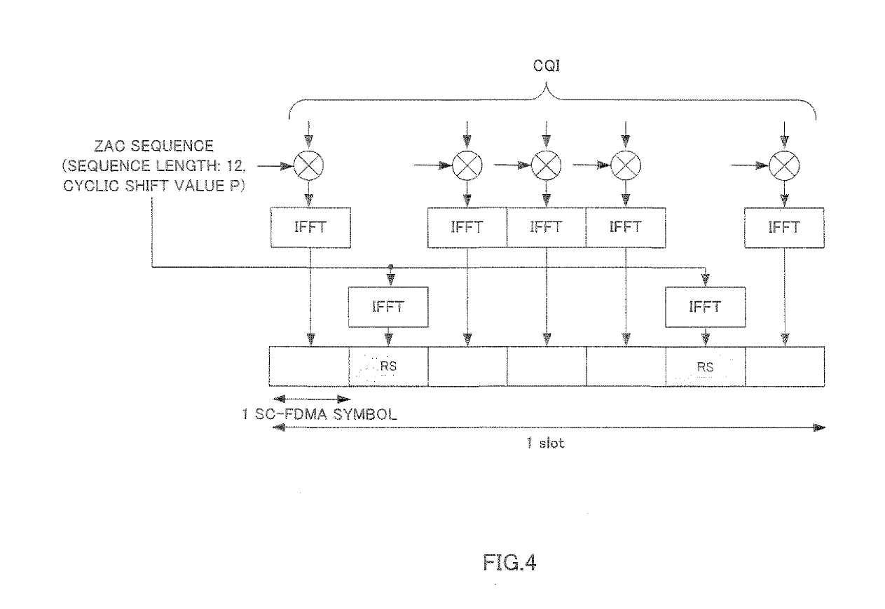

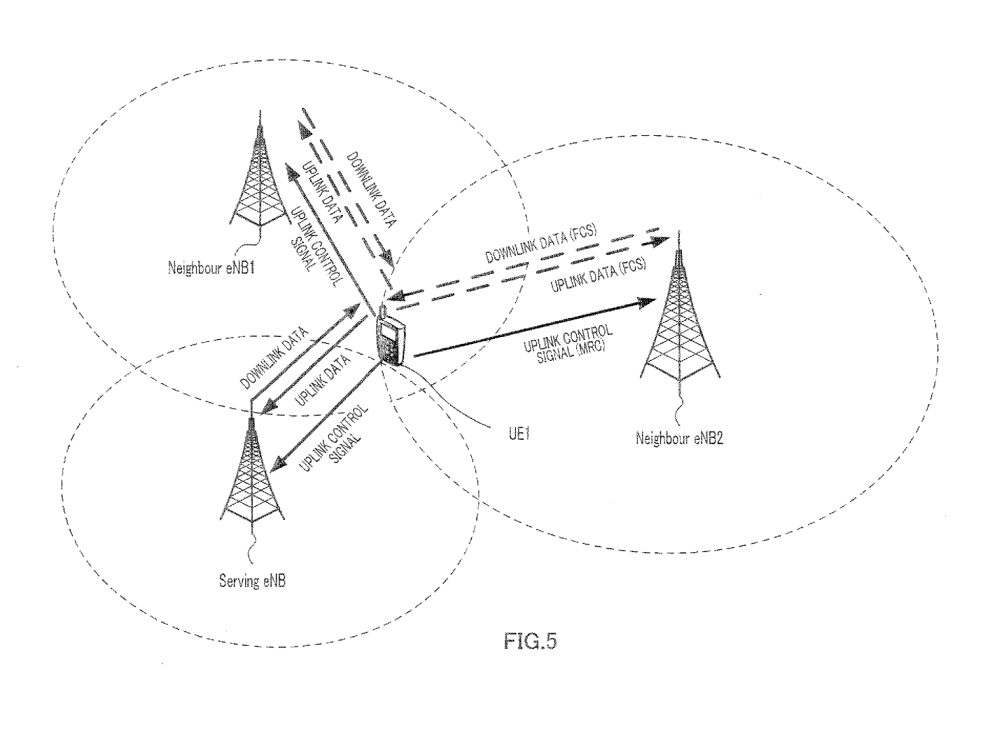

### DESCRIPTION OF EMBODIMENTS

Now, embodiments of the present invention will be described in detail with reference to the accompanying drawings.

### Embodiment 1

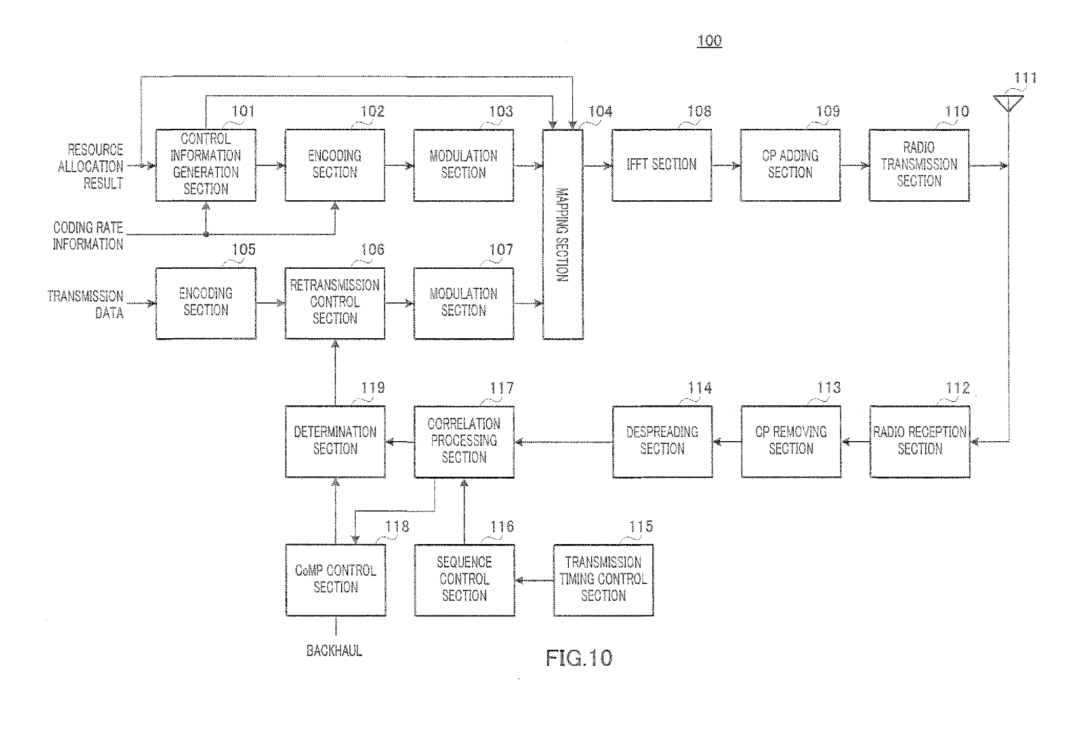

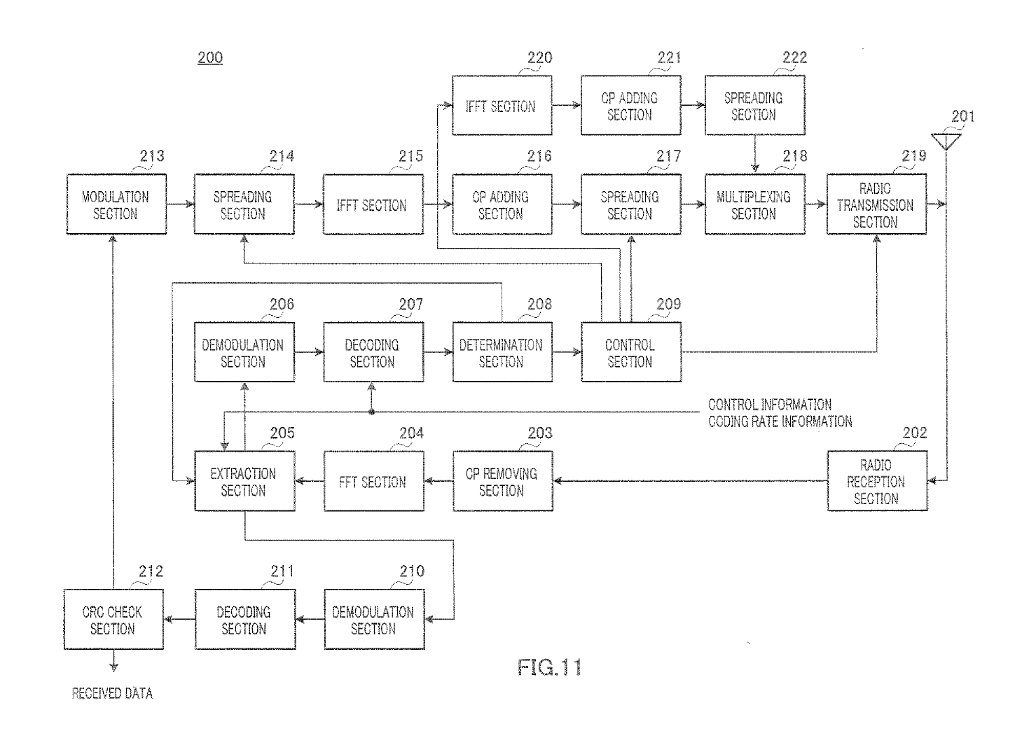

The configuration of base station 100 according to this embodiment is shown in FIG. 10, and the configuration of terminal 200 according to this embodiment is shown in FIG. 11.

To simplify the explanation, FIG. 10 shows only configuration parts involved in downlink data transmission, and uplink reception of a response signal in response to that downlink data, which are closely related to the present invention, and configuration parts involved in uplink data reception are not illustrated or described.

Similarly, FIG. 11 shows only configuration parts involved in downlink data reception, and uplink transmission of a response signal in response to that downlink data, which are closely related to the present invention, and configuration parts involved in uplink data transmission are not illustrated or described.

In the following description, a case is described in which a ZAC sequence is used for first spreading and a blockwise spread code sequence is used for second spreading. However, a sequence other than a ZAC sequence that allows mutual separation by means of mutually different cyclic shift values may also be used. For example, a GCL (Generalized Chirp like) sequence, CAZAC (Constant Amplitude Zero Auto Correlation) sequence, ZC (Zadoff-Chu) sequence, M sequence, or orthogonal Gold code sequence or suchlike PN sequence, or a sequence with a steep autocorrelation characteristic in the time domain randomly generated by a computer or the like, may also be used for first spreading. Also, for second spreading, any sequences that are orthogonal to each other or that are virtually orthogonal to each other can be used as blockwise spreading code sequences. A Walsh sequence, Fourier sequence, or the like, for example, can be used as a blockwise spread code sequence for second spreading.

Also, in the following description, a response signal resource (for example, a PUCCH or PRB) is defined by means of a cyclic shift value of a ZAC sequence and a sequence number of a blockwise spread code sequence.

Furthermore, in the following description, a time/frequency resource (for example, a PRB) and a code resource (cyclic shift value) used for uplink signal transmission by a CoMP terminal are adjusted beforehand among a plurality of base stations participating in CoMP. Also, each base station separately specifies to a terminal a transmission timing control value indicating uplink data (or response signal) transmission timing.

In base station 100 shown in FIG. 10, a downlink data resource allocation result is input to control information generation section 101 and mapping section 104. Also, a downlink data resource allocation result is input to control information generation section 101 and encoding section 102 as a per-terminal coding rate of control information for reporting a downlink data resource allocation result.

Control information generation section 101 generates control information for reporting a downlink data resource allocation result on a terminal-by-terminal basis, and outputs this to encoding section 102. Terminal-specific control information includes terminal ID information indicating to which terminal the control information is addressed. For example, a CRC bit masked by the ID number of a control information notification destination terminal is included in control information as terminal ID information.

Encoding section 102 encodes terminal-specific control information in accordance with input coding rate information, and outputs encoded control information to modulation section 103.

Modulation section 103 modulates post-encoding control information, and outputs modulated control information to mapping section 104.

On the other hand, encoding section 105 encodes transmission data (downlink data) for each terminal, and outputs encoded transmission data to retransmission control section 106.

At the time of an initial transmission, retransmission control section 106 holds post-encoding transmission data for each terminal and also outputs this transmission data to modulation section 107. Retransmission control section 106 holds transmission data until ACK from a terminal is input from determination section 119. Also, if NACK from a terminal is input—that is, at the time of a retransmission—retransmission control section 106 outputs transmission data corresponding to that NACK to modulation section 107.

Modulation section 107 modulates post-encoding transmission data input from retransmission control section 106, and outputs modulated transmission data to mapping section 104.

At the time of control information transmission, mapping section 104 maps control information input from modulation section 103 onto a physical resource (time/frequency resource) in accordance with a resource allocation result input from control information generation section 101, and outputs the result to IFFT section 108.

On the other hand, at the time of downlink data transmission, mapping section 104 maps transmission data for each terminal onto a physical resource in accordance with a resource allocation result, and outputs the result to IFFT section 108. That is to say, mapping section 104 maps per-terminal transmission data onto any of a plurality of subcarriers composing an OFDM symbol in accordance with a resource allocation result.

IFFT section 108 performs an IFFT on a plurality of subcarriers onto which control information or transmission data has been mapped and generates an OFDM symbol, and outputs this to CP adding section 109.

CP adding section 109 adds a signal that is the same as the end part of an OFDM symbol to the front of the OFDM symbol as a CP.

Radio transmission section 110 performs transmission processing such as D/A conversion, amplification, and up-conversion, on a post-CP-addition OFDM symbol, and transmits the OFDM symbol to terminal 200 (FIG. 11) from antenna 111.

On the other hand, radio reception section 112 receives, via antenna 111, a response signal or reference signal transmitted from terminal 200, and performs reception processing such as down-conversion and A/D conversion on the response signal or reference signal.

CP removing section 113 removes a CP added to a post-reception-processing response signal or reference signal.

Despreading section 114 despreads a response signal by means of a blockwise spread code sequence used for second spreading in terminal 200, and outputs a post-despreading response signal to correlation processing section 117. Similarly, despreading section 114 despreads a reference signal by means of an orthogonal sequence used for reference signal spreading in terminal 200, and outputs a post-despreading reference signal to correlation processing section 117.

Transmission timing control section 115 holds a transmission timing control value of uplink data (or a response signal) specified separately to each terminal, and outputs a transmission timing control value used at the time of transmission of a response signal transmitted from terminal 200 to sequence control section 116.

Sequence control section 116 generates a ZAC sequence used for spreading of a response signal transmitted from terminal 200. Also, sequence control section 116 identifies a correlation window that includes a signal component from terminal 200 based on a resource (for example, a cyclic shift value) used in correspondence to terminal 200 transmission timing control, which is calculated using a transmission timing control value input from transmission timing control section 115. Then sequence control section 116 outputs information indicating the identified correlation window, and the generated ZAC sequence, to correlation processing section 117.

Using information indicating an identified correlation window, and a ZAC sequence, that are input from sequence control section 116, correlation processing section 117 finds a correlation value between a post-despreading response signal and post-despreading reference signal, and a ZAC sequence used for first spreading in terminal 200, and outputs this to determination section 119 and CoMP control section 118.

If this base station 100 is operating as a serving eNB for a terminal that transmitted a response signal (that is, if a terminal that transmitted a response signal belongs to this base station 100), CoMP control section 118 outputs information from another base station participating in the same CoMP group as this station (that is, a correlation value of a response signal found by another base station), which is transmitted via backhaul, to determination section 119. On the other hand, if this base station 100 is not a serving eNB for a terminal that transmitted a response signal (that is, if a terminal that transmitted a response signal does not belong to this base station 100), CoMP control section 118 transmits a correlation value input from correlation processing section 117 (a response signal correlation value found by this station) to another base station participating in the same CoMP group as this station via backhaul.

Determination section 119 combines a correlation value input from correlation processing section 117 and a correlation value input from CoMP control section 118 (a correlation value of a response signal received by another base station participating in the same CoMP group as base station 100) by means of MRC or the like, for example. Then, based on the result of that combination, determination section 119 determines whether a per-terminal response signal is ACK or NACK by means of coherent detection using a reference signal correlation value. Determination section 119 then outputs a per-terminal ACK or NACK to retransmission control section 106.

On the other hand, in terminal 200 shown in FIG. 11 radio reception section 202 receives, via antenna 201, an OFDM symbol transmitted from base station 100, and performs reception processing such as down-conversion and A/D conversion on the OFDM symbol.

CP removing section 203 removes a CP added to a post-reception-processing OFDM symbol.

FFT section 204 performs an FFT on an OFDM symbol and obtains control information or downlink data mapped onto a plurality of subcarriers, and outputs these to extraction section 205.

Coding rate information indicating a control information coding rate is input to extraction section 205 and decoding section 207.

At the time of control information reception, extraction section 205 extracts control information from a plurality of subcarriers in accordance with input coding rate information, and outputs this control information to demodulation section 206.

Demodulation section 206 demodulates control information and outputs demodulated control information to decoding section 207.

Decoding section 207 decodes control information in accordance with input coding rate information, and outputs decoded control information to encoding section 208.

On the other hand, at the time of downlink data reception, extraction section 205 extracts downlink data addressed to this terminal 200 from a plurality of subcarriers in accordance with a resource allocation result input from encoding section 208, and outputs this downlink data to demodulation section 210. This downlink data is demodulated by demodulation section 210 and decoded by decoding section 211, and is input to CRC check section 212.

CRC check section 212 performs error detection using a CRC on post-decoding downlink data, generates ACK as a response signal if CRC=OK (no error), or NACK if CRC=NG (error present), and outputs the generated response signal to modulation section 213. Also, if CRC=OK (no error), CRC check section 212 outputs post-decoding downlink data as received data.

Determination section 208 performs blind determination as to whether or not control information input from decoding section 207 is control information addressed to this terminal 200. For example, determination section 208 determines that control information for which CRC=OK (no error) is control information addressed to this terminal 200 by demasking a CRC bit with the ID number of this terminal 200. Then determination section 208 outputs control information addressed to this terminal 200—that is, a downlink data resource allocation result for this terminal 200—to extraction section 205.

Determination section 208 determines whether or not there is allocation of downlink data for this terminal 200—that is, whether or not a response signal should be transmitted—and outputs the determination result to control section 209.

Control section 209 holds information indicating a time/frequency resource (for example, a PRB (Physical Resource Block)) to which a response signal transmitted from terminal 200 is allocated, reported beforehand from base station 100 to which this terminal 200 belongs, information indicating code resources (ZAC sequence and cyclic shift value) reported from a base station when this terminal starts CoMP communication, and a transmission timing control value used for response signal transmission in the past and a transmission timing control value used for present response signal transmission.

When transmitting a response signal that is CoMP-received, control section 209 sets a held ZAC sequence (that is, a ZAC sequence reported from a base station beforehand). At this time, control section 209 controls a cyclic shift value of a ZAC sequence used for first spreading by spreading section 214, using a difference between a transmission timing control value of a past response signal and a transmission timing control value of a present response signal, and a cyclic shift value of a response signal reported when CoMP communication is started (that is, a cyclic shift value used for past response signal transmission). By this means, control section 209 sets a ZAC sequence used for first spreading by spreading section 214. Also, control section 209 controls a blockwise spread code sequence used for second spreading by spreading section 217 in accordance with a notification from a base station. Control section 209 outputs a present response signal transmission timing control value to radio transmission section 219. Details of sequence control by control section 209 will be given later herein. Furthermore, control section 209 outputs a ZAC sequence to IFFT section 220 as a reference signal.

Modulation section 213 modulates a response signal input from CRC check section 212, and outputs a modulated response signal to spreading section 214.

Spreading section 214 performs first spreading of a response signal using a ZAC sequence set by control section 209, and outputs a post-first-spreading response signal to IFFT section 215. That is to say, spreading section 214 performs first spreading of a response signal in accordance with a directive from control section 209.

IFFT section 215 performs an IFFT on a post-first-spreading response signal, and outputs a post-IFFT response signal to CP adding section 216.

CP adding section 216 adds a signal that is the same as the end part of a post-IFFT response signal to the front of that response signal as a CP.

Spreading section 217 performs second spreading of a post-CP-addition response signal using a blockwise spread code sequence set by control section 209, and outputs a post-second-spreading response signal to multiplexing section 218. That is to say, spreading section 217 performs second spreading of a post-first-spreading response signal using a blockwise spread code sequence corresponding to a resource selected by control section 209.

IFFT section 220 performs an IFFT on a reference signal, and outputs a post-IFFT reference signal to CP adding section 221.

CP adding section 221 adds a signal that is the same as the end part of a post-IFFT reference signal to the front of that reference signal as a CP.

Spreading section 222 spreads a post-CP-addition reference signal by means of a preset orthogonal sequence, and outputs a post-spreading reference signal to multiplexing section 218.

Multiplexing section 218 time-multiplexes a post-second-spreading response signal and a post-spreading reference signal in one slot, and outputs the resulting signal to radio transmission section 219.

Radio transmission section 219 performs transmission processing such as D/A conversion, amplification, and up-conversion, on a post-second-spreading response signal or post-spreading reference signal. Then radio transmission section 219 adjusts the signal transmission timing based on a transmission timing control value input from control section 209, and transmits the signal to base station 100 (FIG. 10) from antenna 201.

Sequence control by control section 209 will now be described in detail.

In the following description, a cyclic shift sequence with a sequence length of 12 in the time domain (for example, a ZAC sequence) is used. Here, cyclic shift sequence f˜ₘ(nₜ) with a cyclic shift value of m is represented by equation 1 below.

[1]

\tilde{f}ₘ(nₜ)=f((nₜ+m)mod 12) (Equation 1)

Here, nₜ=0, 1, . . . , 11, f(nₜ) is a cyclic shift sequence with a cyclic shift value of 0 (a base ZAC sequence), and operator “mod” represents a modulo operator. The cyclic shift sequence shown in equation 1 is expressed in the frequency domain by equation 2 below.

$$\begin{matrix}( Equation 2 ) & \\ {\tilde{F}}_{m} ( {n}_{f} ) = F ( {n}_{f} ) \cdot {e}^{j \frac{2 π m}{12} {n}_{f}} & [ 2 ]\end{matrix}$$

Here, F(n_{f}) is a notation for f(nₜ) in the frequency domain, and n_{f}=0, 1, . . . , 11. That is to say, all cyclic shift values (real values) of cyclic shift sequences in the time domain can be represented in the frequency domain.

Here, a cyclic shift value used for response signal transmission by terminal 200 at certain timing n (for example, subframe n or time n) is designated mₙ, and a transmission timing control value used by terminal 200 at the same timing n is designated tₙ. At this time, when transmission timing control value tₙ₊₁ is reported at timing (n+1) later than timing n, control section 209 calculates cyclic shift value mₙ₊₁ shown in equation 3 below. Transmission timing control values (tₙ and tₙ₊₁) at different timings (timing n and timing (n+1)) are not necessarily different from each other.

$$\begin{matrix}( Equation 3 ) & \\ {m}_{n + 1} = \{ \begin{matrix}{m}_{n} & if ( {t}_{n + 1} - {t}_{n} ) < {t}_{thre} \\ {m}_{n} - \frac{( {t}_{n + 1} - {t}_{n} )}{τ} & otherwise\end{matrix} & [ 3 ]\end{matrix}$$

Here, τ indicates time corresponding to one cyclic shift value in the time domain, and tₜₕᵣₑ indicates a threshold value.

That is to say, control section 209 controls a cyclic shift value of a cyclic shift sequence (ZAC sequence) used by spreading section 214 at timing (n+1) according to a difference between a response signal transmission timing control value at a certain time (timing n) and a response signal transmission timing control value at a time later than timing n (here, timing (n+1)).

Specifically, if the difference between response signal transmission timing control value tₙ at timing n and response signal transmission timing control value tₙ₊₁ at timing (n+1) is less than threshold value t_{tbre} ((tₙ₊₁−tₙ)<tₜₕᵣₑ), control section 209 sets cyclic shift value mₙ at timing n as cyclic shift value mₙ₊₁ at timing (n+1).

On the other hand, if the difference between response signal transmission timing control value tₙ at timing n and response signal transmission timing control value tₙ₊₁ at timing (n+1) is greater than or equal to threshold value tₜₕᵣₑ, control section 209 adjusts cyclic shift value mₙ at timing n with a cyclic shift value corresponding to the difference between the transmission timing control values. Specifically, as shown in equation 3, control section 209 calculates cyclic shift value mₙ₊₁ at timing (n+1) by adjusting cyclic shift value mₙ with cyclic shift value ((tₙ₊₁−tₙ/τ) corresponding to difference (tₙ₊₁−tₙ) between transmission timing control value tₙ₊₁ at timing (n+1) and transmission timing control value tₙ at timing n.

By this means, when a response signal transmission timing control value changes, if the amount of change of the transmission timing control value (that is, difference (tₙ₊₁−tₙ)) is greater than or equal to a threshold value, control section 209 adjusts the cyclic shift value with an amount of change (deviation on the cyclic shift axis) of the cyclic shift value corresponding to an amount of change (deviation in the time domain) of that transmission timing control value. In other words, control section 209 ensures influence exerted on a cyclic shift value by a change in the transmission timing control value (here, an amount resulting from normalizing difference (tₙ₊₁−tₙ) by time τ corresponding to one cyclic shift value) in the frequency domain.

Then spreading section 214 spreads a response signal by means of a cyclic shift sequence (ZAC sequence) with a cyclic shift value (real value) that takes transmission timing deviation into consideration.

By this means, each base station can keep an encoding resource (cyclic shift value) occupied by a response signal from a CoMP terminal (terminal 200) constant at all times, irrespective of the CoMP terminal (terminal 200) transmission timing control value.

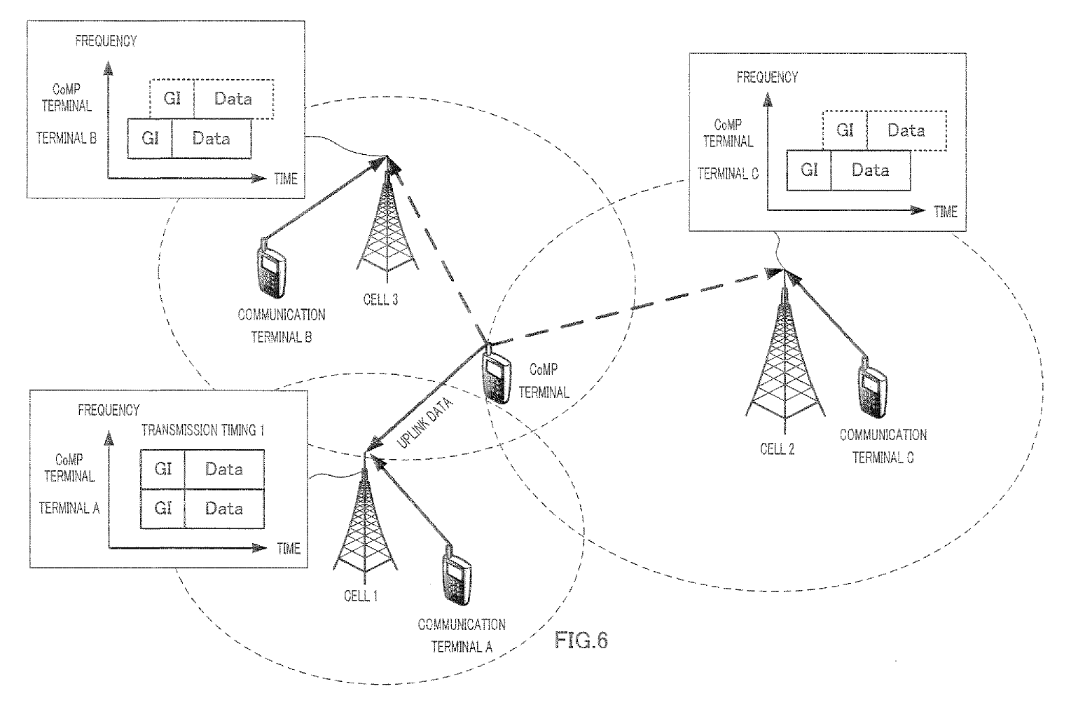

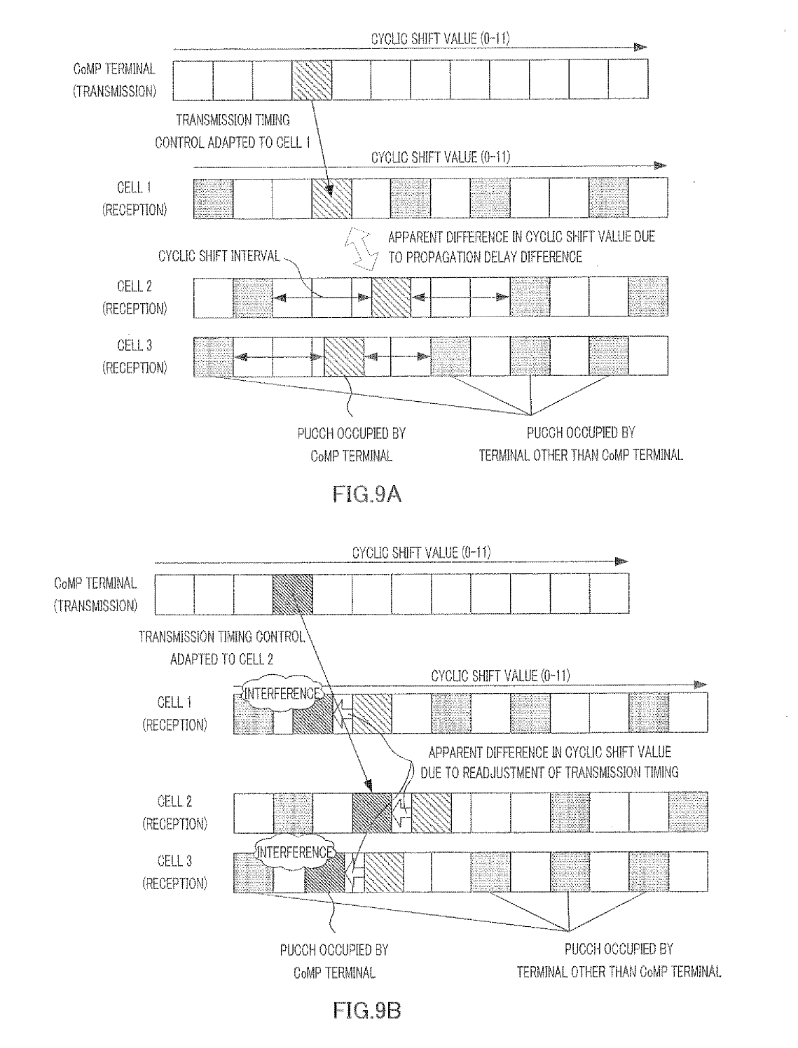

For example, a case will be described in which, at certain timing n (for example, subframe n or time n), a CoMP terminal (terminal 200) spreads a response signal by means of a cyclic shift sequence (ZAC sequence) for which cyclic shift value mₙ=3, as shown in FIG. 9A. Also, at timing n, as shown in FIG. 6, transmission timing control value tₙ adapted to cell 1 (timing 1 in FIG. 6) is reported to the CoMP terminal. Therefore, as shown in FIG. 9A, cells 1 through 3 control a PUCCH occupied by a terminal other than the CoMP terminal, taking a PUCCH occupied by the CoMP terminal into consideration.

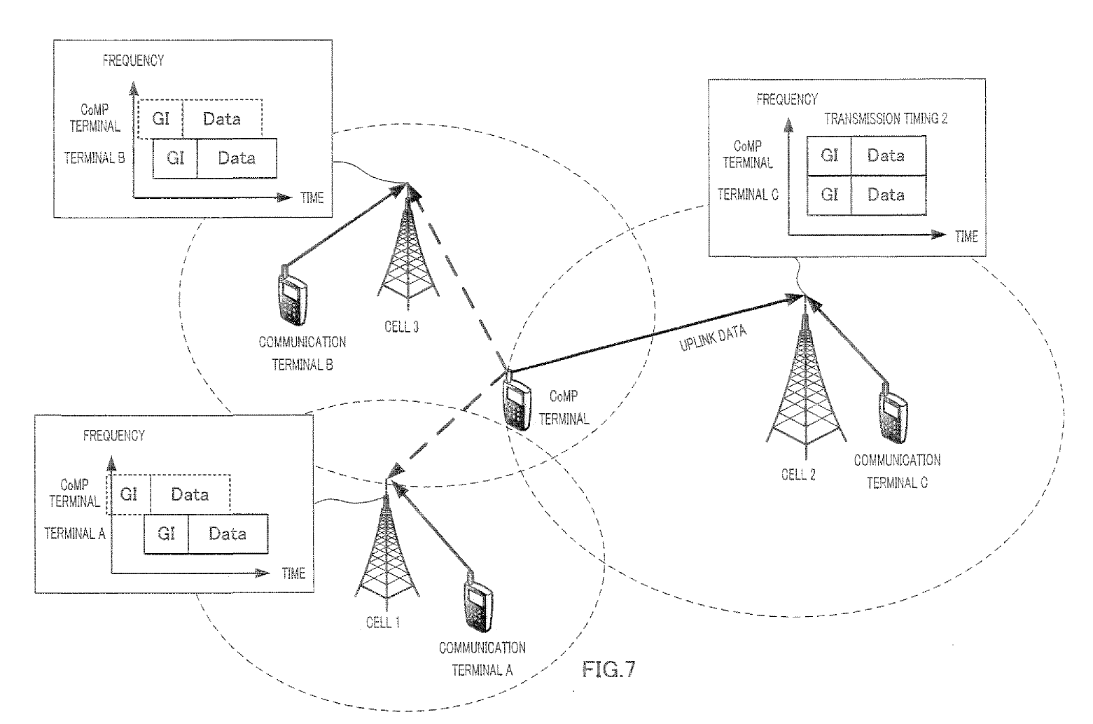

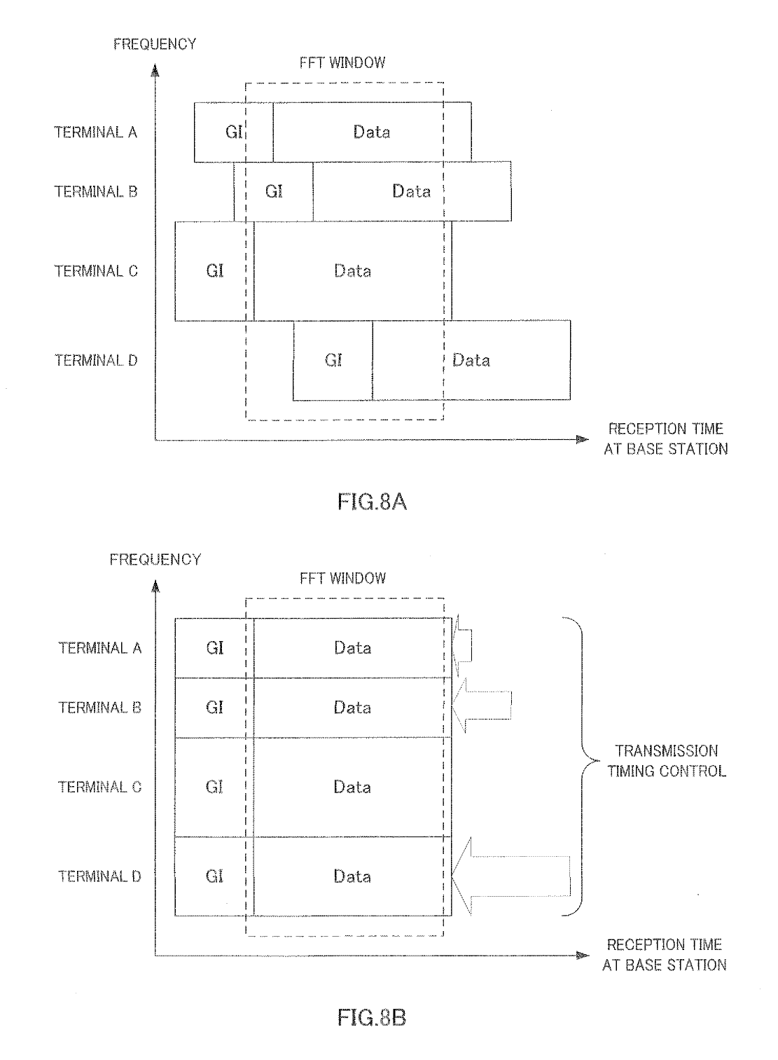

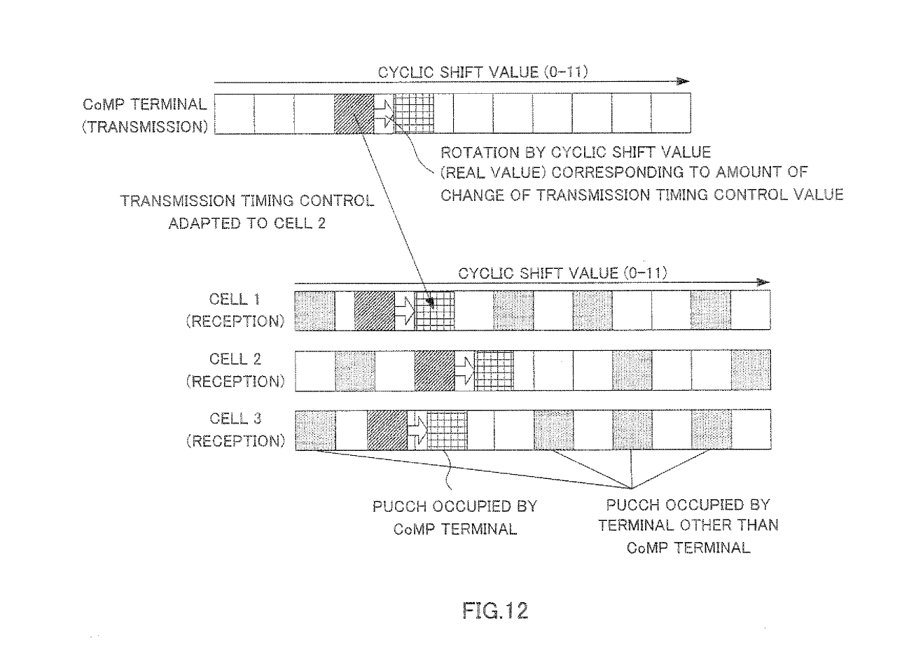

Here, it is assumed that, at timing (n+1) later than timing n, transmission timing control value tₙ₊₁ adapted to cell 2 (timing 2 shown in FIG. 7) is reported to the CoMP terminal together with FCS control. In this case, control section 209 calculates cyclic shift value mₙ₊₁ at timing (n+1) by adjusting cyclic shift value in based on equation 3. Then, as shown in FIG. 12, the CoMP terminal spreads a response signal using cyclic shift value mₙ₊₁ resulting from rotating cyclic shift value mₙ at timing n (a cyclic shift value of 3) by cyclic shift value ((tₙ₊₁−tₙ)/τ) corresponding to a difference between transmission timing control values (tₙ₊₁−tₙ, where tₙ₊₁−tₙ is greater than or equal to tₜₕᵣₑ). By this means, as shown in FIG. 12, at timing (n+1) a response signal from the CoMP terminal is received in each cell occupying the same code resource as at timing n (FIG. 9A). Consequently, inter-code interference does not occur in code resources occupied by response signals from a plurality of terminals including a CoMP terminal in any of the cells. Also, in each cell, a code resource (cyclic shift value) set for each terminal can be kept constant irrespective of a transmission timing control value, enabling resource management to be performed efficiently without considering a change of transmission timing control value in a CoMP terminal.

Thus, in this embodiment, when a transmission timing control value changes, a CoMP terminal adjusts a (past) cyclic shift value prior to the transmission timing control value change with a cyclic shift value corresponding to the amount of change (time difference) of the transmission timing control value. Then the CoMP terminal transmits an uplink control signal spread by means of a cyclic shift sequence with a post-adjustment cyclic shift value. By this means, each base station that performs CoMP reception of an uplink control signal from the CoMP terminal can receive an uplink control signal by means of a constant code resource at all times, even when an uplink control signal transmission timing control value changes. Therefore, according to this embodiment, inter-code interference at a plurality of base stations can be prevented even when the transmission timing of a control signal CoMP-received by the base stations changes.

Also, in this embodiment, a CoMP terminal can determine whether or not a cyclic shift value is to be adjusted by comparing a transmission timing control value difference (amount of change) with a threshold value. That is to say, it is possible for a CoMP terminal to adjust a cyclic shift value only if a transmission timing control value difference (amount of change) is greater than or equal to a threshold value—for example, only if it can be inferred that a base station that chiefly receives response signals from terminal 200 has changed. That is to say, a CoMP terminal no longer adjusts a cyclic shift value unnecessarily when a transmission timing control value difference (amount of change) is less than a threshold value—for example, when a base station that chiefly receives response signals from terminal 200 does not change and fine adjustment of transmission timing due to movement of terminal 200 is performed.

### Embodiment 2

In Embodiment 1, a case was described in which a plurality of base stations perform CoMP reception of a response signal. In contrast, in this embodiment, a case will be described in which a plurality of base stations participating in the same CoMP group perform CoMP transmission of downlink data (a reference signal) to a terminal, and perform CoMP reception of a CQI signal indicating downlink channel quality measured using that downlink data (reference signal).

This will now be described in specific terms. In the following description, a plurality of base stations participating in the same CoMP group perform CoMP transmission of a reference signal and downlink data. That is to say, at a terminal, code-multiplexed reference signals from a plurality of base stations are received. Also, a base station notifies a terminal beforehand of information indicating a resource (for example, a PRB) used for CQI signal transmission. Furthermore, a base station provides separate notification of a transmission timing control value for controlling transmission timing of a signal transmitted by a terminal.

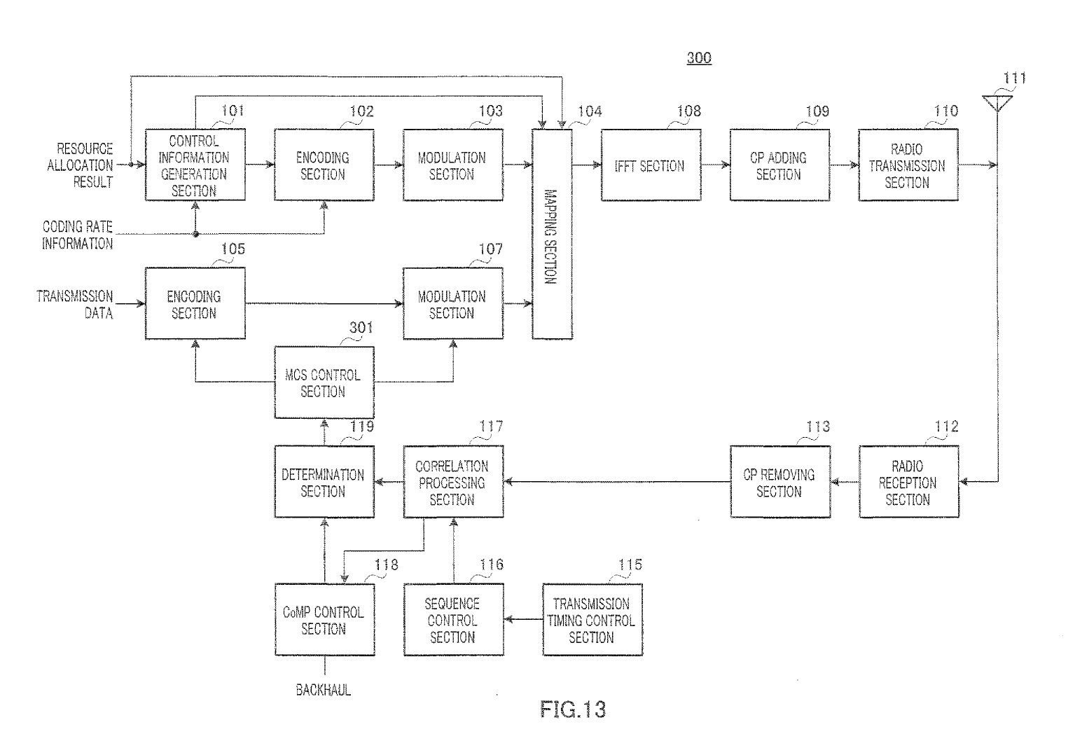

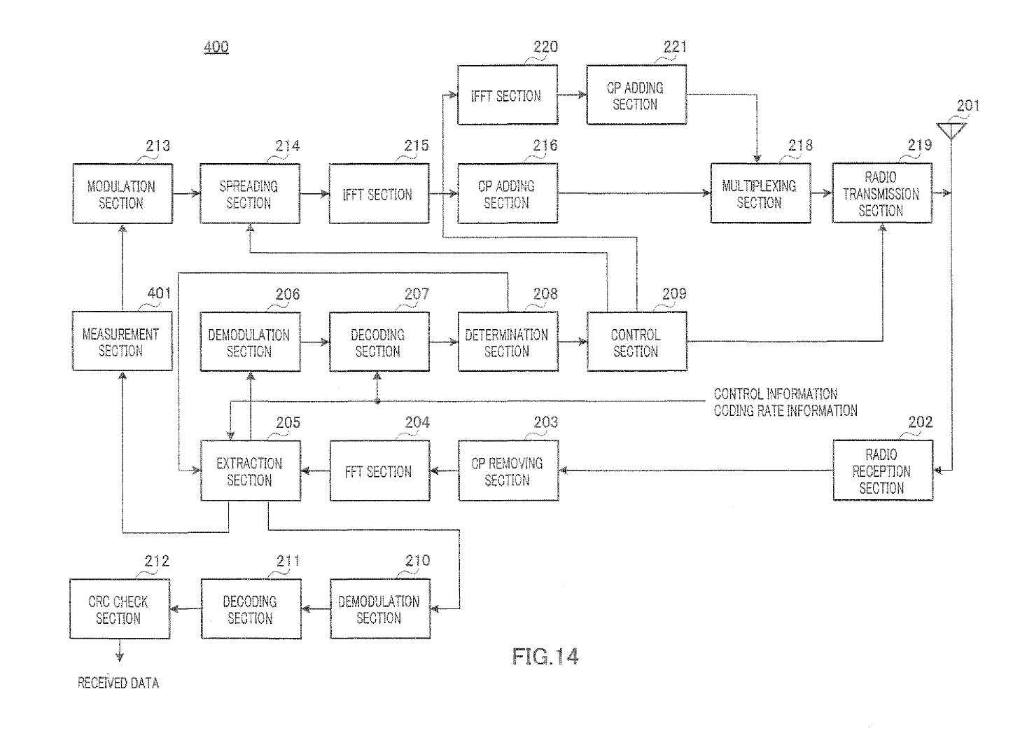

The configuration of base station 300 according to this embodiment is shown in FIG. 13, and the configuration of terminal 400 according to this embodiment is shown in FIG. 14. Configuration parts in FIG. 13 identical to those in FIG. 10 (Embodiment 1) are assigned the same reference codes as in FIG. 10, and descriptions thereof are omitted here. Similarly, configuration parts in FIG. 14 identical to those in FIG. 11 (Embodiment 1) are assigned the same reference codes as in FIG. 11, and descriptions thereof are omitted here. Also, since second spreading by means of an orthogonal code sequence (Walsh sequence, Fourier sequence, or the like) is not performed on a CQI signal, despreading section 114 shown in FIG. 10 is unnecessary in base station 300 shown in FIG. 13, and spreading section 217 shown in FIG. 11 is unnecessary in terminal 400 shown in FIG. 14.

In base station 300 shown in FIG. 13, analog information of a CQI signal received by another base station participating in the same CoMP group as this base station 100 is input to determination section 119 from CoMP control section 118 via backhaul. Also, a CQI signal received by this base station 100 is input to determination section 119 from correlation processing section 117. Determination section 119 combines a correlation value input from correlation processing section 117 and a CQI signal input from CoMP control section 118, and demodulates a CQI signal that is the result of that combination. Also, CoMP control section 118 transmits analog information of a CQI signal received by this station to another base station participating in the same CoMP group as this station 100 via backhaul.

MCS control section 301 extracts CQI information addressed to this base station 100 from CQI information of a plurality of base stations included in a CQI signal input from determination section 119, and performs MCS (coding rate and modulation method) control based on this CQI information addressed to this base station 100. Then MCS control section 301 outputs a controlled coding rate to encoding section 105 and outputs a controlled modulation method to modulation section 107.

Encoding section 105 encodes transmission data in accordance with a coding rate input from MCS control section 301, and modulation section 107 modulates post-encoding transmission data in accordance with a modulation method input from MCS control section 301.

On the other hand, in terminal 400 shown in FIG. 14, extraction section 205 extracts a reference signal CoMP-transmitted from a plurality of base stations participating in the same CoMP group (a signal in which reference signals from each base station are code-multiplexed) to measurement section 401.

Using a reference signal input from extraction section 205, measurement section 401 measures downlink quality between this terminal 200 and each base station. Here, it is difficult to have CQI information indicating downlink quality for each of a plurality of base stations arrive individually at all base stations participating in a COMP group. Thus, for example, measurement section 401 compresses CQI information indicated measured downlink quality for each of a plurality of base stations into one CQI signal. Then measurement section 401 outputs a CQI signal that includes CQI information of a plurality of base stations to modulation section 213.

Control section 209 of terminal 400 according to this embodiment will now be described in detail.

Control section 209 holds information indicating a time/frequency resource to which a CQI signal transmitted from this terminal 200 is allocated, reported beforehand from base station 300 to which this terminal belongs, information indicating code resources (ZAC sequence and cyclic shift value) reported from a base station when this terminal starts CoMP communication, and a transmission timing control value used for CQI signal transmission in the past and a transmission timing control value used for present CQI signal transmission.

When a transmission timing control value used for present CQI signal transmission changes with respect to a transmission timing control value used for past CQI signal transmission, if an amount of change of the transmission timing control value is less than a threshold value, control section 209 sets a cyclic shift value used for past CQI signal transmission as a cyclic shift value used for present CQI signal transmission, similarly to the case in Embodiment 1. Also, if an amount of change of the transmission timing control value is greater than or equal to a threshold value, control section 209 calculates a cyclic shift value to be used for present CQT signal transmission by adjusting a cyclic shift value used for past CQI signal transmission with an amount of change (deviation on the cyclic shift axis) of the cyclic shift value corresponding to an amount of change (deviation in the time domain) of the transmission timing control value, similarly to the case in Embodiment 1.

By this means, each base station can keep an encoding resource (cyclic shift value) occupied by a CQI signal from a CoMP terminal (terminal 400) constant at all times, irrespective of the CoMP terminal (terminal 400) transmission timing control value. Therefore, inter-code interference does not occur in code resources occupied by CQI signals from a plurality of terminals including a CoMP terminal at any of the base stations, similarly to the case in Embodiment 1.

Thus, according to this embodiment, the same kind of effect as in Embodiment 1 can also be obtained when a CQI signal is CoMP-received. That is to say, since interference between CQI signals can be prevented at each base station, CQI signal reception quality can be improved by CoMP reception, and therefore throughput in downlink CoMP transmission can be improved by using higher-precision CQT information.

This concludes a description of embodiments of the present invention.

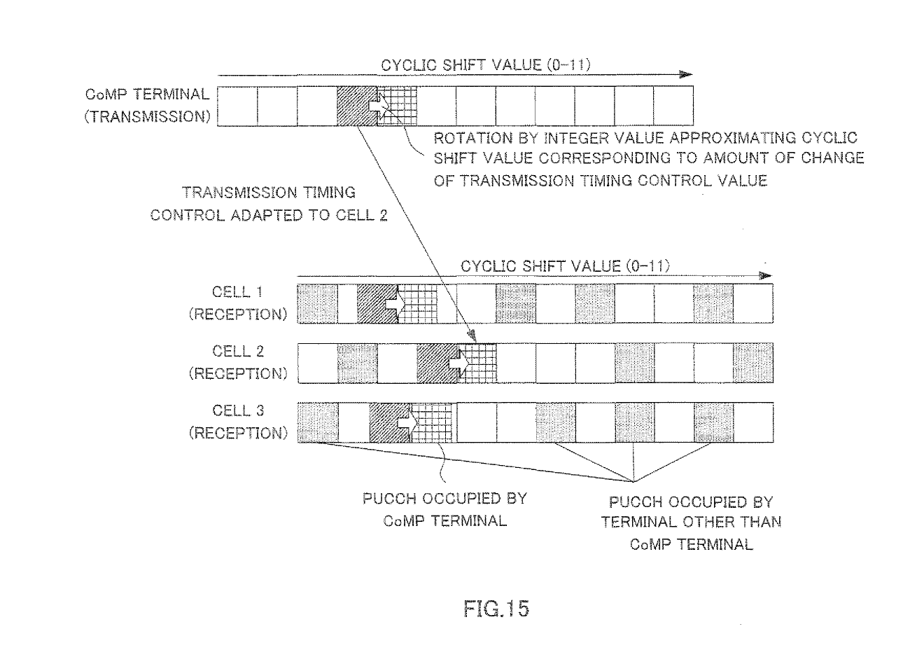

In the above embodiments, a case has been described in which a cyclic shift value calculated based on equation 3 (that is, an amount of change of a cyclic shift value corresponding to an amount of change (difference) in transmission timing control values) is a real number—that is, a case in which an amount of change of a cyclic shift value is not limited to an integer value. However, in the present invention, an amount of change of a cyclic shift value is not limited to a real value, and may also always be made an integer value, as shown in FIG. 15 (in FIG. 15, cyclic shift value change amount 1 (equivalent to one cyclic shift value)). For example, a CoMP terminal may calculate a cyclic shift value as shown in equation 4. Specifically, if the difference between transmission timing tₙ of an uplink control signal (response signal or CQI signal) at timing n and uplink control signal transmission timing control value tₙ₊₁ at timing (n+1) that is later than timing n is greater than or equal to a threshold value, control section 209 of a CoMP terminal (terminal 200 or terminal 400) may calculate cyclic shift value mₙ₊₁ at timing (n+1) by adjusting cyclic shift value mₙ at timing n with integer value ([(tₙ₊₁−tₙ)/τ]) approximating cyclic shift value ((tₙ₊₁−tₙ)/τ) corresponding to that difference. Here, operation [x] calculates the most approximate integer value to x. In equation 4, a case is illustrated in which the most approximate integer value to x is calculated using operation [x]. However, equation 4 is not limited to operation [x], and ceil(x), floor(x), or round(x) may also be used, for example, where ceil(x) means rounding up a fractional part of x, floor(x) means rounding down a fractional part of x, and round(x) means rounding a fractional part of x to the nearest integer.

$$\begin{matrix}( Equation 4 ) & \\ {m}_{n + 1} = \{ \begin{matrix}{m}_{n} & if ( {t}_{n + 1} - {t}_{n} ) < {t}_{thre} \\ {m}_{n} - [ \frac{( {t}_{n + 1} - {t}_{n} )}{τ} ] & otherwise\end{matrix} & [ 4 ]\end{matrix}$$

In the above embodiments, a case has been described in which a CoMP terminal transmits an uplink control signal using a value identical to uplink data transmission timing (a transmission timing control value) specified by a base station. However, the present invention is not limited to a case in which a CoMP terminal transmits an uplink control signal at transmission timing identical to uplink data transmission timing, and the present invention can be applied as long as uplink control signal transmission timing changes according to a directive from a base station.

In the above embodiments, a case has been described in which a response signal (ACK/NACK) or CQI signal is CoMP-received on an uplink. However, in the present invention, CoMP-received signals are not limited to CQI signals and response signals. For example, the present invention may also be applied for an RI (Rank Indicator) indicating the rank index of a downlink channel sequence, or an SR (Scheduling Request) for notifying a base station that transmission data has been generated on the terminal side.

Since a PUCCH used in the descriptions of the above embodiments is a channel for feeding back a response signal (ACK/NACK), it is also referred to as an ACK/NACK channel.

A terminal is also referred to as UE, MT, MS, or STA (station), a base station as Node B, BS, or AP, a subcarrier as a tone, and a CP as a guard interval (GI).

The error detection method is not limited to CRC check.

Methods of performing conversion between the frequency domain and the time domain are not limited to IFFT and FFT.

In the above embodiments, a case has been described by way of example in which the present invention is configured as hardware, but it is also possible for the present invention to be implemented by software.

The function blocks used in the descriptions of the above embodiments are typically implemented as LSIs, which are integrated circuits. These may be implemented individually as single chips, or a single chip may incorporate some or all of them. Here, the term LSI has been used, but the terms IC, system LSI, super LSI, or ultra LSI, may also be used according to differences in the degree of integration.

The method of implementing integrated circuitry is not limited to LSI, and implementation by means of dedicated circuitry or a general-purpose processor may also be used An FPGA (Field Programmable Gate Array) for which programming is possible after LSI fabrication, or a reconfigurable processor allowing reconfiguration of circuit cell connections and settings within an LSI, may also be used.

In the event of the introduction of an integrated circuit implementation technology whereby LSI is replaced by a different technology as an advance in, or derivation from, semiconductor technology, integration of the function blocks may of course be performed using that technology. The application of biotechnology or the like is also a possibility.

The disclosure of Japanese Patent Application No. 2008-328731, filed on Dec. 24, 2008, including the specification, drawings and abstract, is incorporated herein by reference in its entirety.

### INDUSTRIAL APPLICABILITY

The present invention is suitable for use in a mobile communication system or the like.

1. A radio communication terminal apparatus comprising:
a spreading section that spreads a signal using one of a plurality of sequences that can be separated from each other depending on mutually different cyclic shift values; and
a control section that controls, according to a difference between transmission timing of the signal at a first time and transmission timing of the signal at a second time that is later than the first time, a cyclic shift value of the used one of the plurality of sequences in the spreading section at the second time.

2. The radio communication terminal apparatus according to claim 1, wherein the control section sets a cyclic shift value at the first time as the cyclic shift value at the second time if the difference is less than a threshold value, and calculates the cyclic shift value at the second time by adjusting the cyclic shift value at the first time with a cyclic shift value corresponding to the difference if the difference is greater than or equal to the threshold value.

3. The radio communication terminal apparatus according to claim 1, wherein the control section calculates the cyclic shift value at the second time by adjusting the cyclic shift value at the first time with an integer value approximating a cyclic shift value corresponding to the difference.

4. A signal spreading method comprising:
spreading a signal using one of a plurality of sequences that can be separated from each other depending on mutually different cyclic shift values; and
controlling, according to a difference between transmission timing of the signal at a first time and transmission timing of the signal at a second time that is later than the first time, a cyclic shift value of the used one of the plurality of sequences in the spreading section at the second time.
